(19) United States
(12) Patent Application Publication
(10) Pub. No.: US 2021/0251438 A1
(43) Pub. Date: Aug. 19, 2021

(54) CLEANING TISSUE, AND ROLLER AND DISPENSER FOR CLEANING TISSUES

(71) Applicant: Emin BEHRAMAJ, Geltendorf (DE)

(72) Inventor: Emin BEHRAMAJ, Geltendorf (DE)

(21) Appl. No.: 16/771,192

(22) PCT Filed: Mar. 9, 2018
(86) PCT No.: PCT/EP2018/055974

§ 371 Date: Apr. 30, 2021

(30) Foreign Application Priority Data
Dec. 11, 2017 (DE) 20 2017 107 520.6

(51) Int. Cl. A47K 10/38; B08B 1/00; A47K 10/42

(52) U.S. Cl. CPC A47K 10/3836; A47K 2010/3266; A47K 10/426; B08B 1/006

(57) ABSTRACT

A dispenser for an unwindable cleaning cloth wound on a hollow cylindrical roll, in particular for a toilet paper roll, comprising a holder attached to a rear cover, whose outside diameter is smaller than the inside diameter of the roller, for accommodating the roll of the coiled cleaning cloth, wherein the holder is hollow cylindrical in shape and configured with an open end facing the rear cover, wherein inside the cavity of the holder one or more wet wipes can be stored, which can be removed and refilled through the open end.

The present application is a U.S. National Phase of International Patent Application Serial No. PCT/EP2018/055974 entitled “CLEANING TISSUE, AND ROLLER AND DISPENSER FOR CLEANING TISSUES,” filed on Mar. 9, 2018. International Patent Application Serial No. PCT/EP2018/055974 claims priority to German Patent Application No. 20 2017 107 520.6 filed on Dec. 11, 2017. The entire contents of each of the above-referenced applications are hereby incorporated by reference for all purposes.

The present invention relates to a cleaning cloth as well as a roll and a dispenser for cleaning cloths.

Toilet paper as well as dispensers and rolls therefor are known from the prior art in a wide variety of designs. Usually, toilet paper is employed as a long multi-layer strip which is wound up onto a hollow-cylindrical roll mostly consisting of cardboard. Furthermore, the strip typically is divided into a plurality of coherent portions along the longitudinal direction by perforations, which portions can be torn off by hand during unwinding.

It is known that in certain situations moistened toilet paper or wet wipes lead to an improved cleaning effect as compared to dry wipes. So far, however, wet wipes and dry toilet paper are stored and used separately in most cases. In the form described above, the toilet paper usually is employed as an unwindable coiled strip and for example is rotatably stored in a holder, whereas wet wipes are stored in a separate lockable package or box which prevents drying out.

In many situations, however, it would be desirable to have dry toilet paper and wet wipes within reach at the same time, without having to store and/or buy both goods separately.

Combined dispensers for dry and/or moist toilet paper are known from the prior art. For example, DE 10 2010 036 072 A1 discloses a dispenser for dry and moist toilet paper with an integrated moistening device which upon request applies a moistening liquid onto a surface of a toilet paper web. Such devices, however, are comparatively complicated, expensive and require a lot of space.

Therefore, it is the object underlying the present invention to provide an apparatus of simple design, which provides dry and moist cleaning cloths at the same time.

In accordance with the invention, this object is achieved by a dispenser for a cleaning cloth with the features of claim 1, a roll on which a cleaning cloth is wound with the features of claim 8, and a cleaning cloth with the features of claim 12. Advantageous embodiments of the invention can be taken from the sub-claims following the coordinated independent claims.

On the one hand, there is proposed a dispenser for an unwindable cleaning cloth wound up on a hollow-cylindrical roll, in particular for a toilet paper roll. The dispenser includes a holder attached to a rear cover for accommodating the roll of the coiled cleaning cloth, whose outside diameter is smaller than the inside diameter of the roll. In accordance with the invention, the holder is of hollow-cylindrical shape and configured with an open end facing the rear cover, wherein inside of the cavity of the holder one or more wet wipes can be stored, which can be removed and refilled through the open end.

With the hollow-cylindrical holder, the dispenser according to the invention provides an apparatus in which wet wipes can be stored and be removed therefrom when necessary. At the same time, a commercially available toilet paper wound up on a roll can be put onto the holder and can be unwound or torn off in the customary way. Commercially available wet wipes, which can be refilled when necessary, can likewise be used in the dispenser. Due to the dispenser according to the invention, a separate storage of wet wipes and toilet paper can be omitted.

In one embodiment of the dispenser it is provided that a grab handle is provided. The dispenser according to the invention thereby is comfortable to transport and can be used in any location and on the way.

In another embodiment of the dispenser it is provided that at least two standing feet are provided, which preferably are arranged on the underside of the dispenser.

In another embodiment of the dispenser it is provided that at least one fastening means is provided, by means of which the dispenser can be attached to a wall. The fastening means for example can be tabs or eyelets for attachment to a wall by means of screws. The dispenser according to the invention thereby can be used in a known way as a firmly positioned toilet paper holder with an additionally integrated wet wipe dispenser.

In another embodiment of the dispenser it is provided that the dispenser includes a housing which completely or almost completely encloses a coiled cleaning cloth stored therein, wherein the rear cover is part of the housing. The housing includes an opening, preferably a slot, for unrolling and removing the cleaning cloth. The side of the housing facing the rear cover furthermore is formed by a first lid to be opened and closed, which preferably is pivotally mounted on the housing. The first lid closes off the housing in which the cleaning cloth is stored. The interior space of the holder, in which the wet wipes are stored, likewise is closed off, so that the wet wipes are prevented from drying out.

In another embodiment of the dispenser it is provided that the first lid has an opening which covers the open side of the holder when the first lid is closed, wherein on the first lid a second lid preferably is pivotally mounted, which can be opened and closed and which in the closed state closes the opening of the first lid. With the second lid open, wet wipes can be removed from the cavity of the holder or wet wipes can be refilled without having to open the first lid, which closes off the space between holder and housing in which the cleaning cloth is stored. In this exemplary embodiment, the first lid has to be removed merely for replacing the cleaning cloth, wherein the removal of the wet wipes through the second lid is decoupled therefrom.

In another embodiment of the dispenser it is provided that the housing deviates from the substantially cylindrical shape of the coiled cleaning cloth, wherein the interspaces resulting from the deviation are configured as additional storage compartments. For example, it is conceivable that in the resulting additional space tampons, cotton pads, cotton swabs or any other goods or sanitary articles can be stored.

The present invention furthermore comprises a roll on which a dry cleaning cloth, in particular toilet paper, is wound up so as to be unwound. The roll is configured as a hollow cylinder with at least one open side. In accordance with the invention, the cavity of the roll contains one or more wet wipes which can be removed and/or refilled through the at least one open side of the roll.

The roll is provided together with the wet wipes, and after completely unrolling the cleaning cloth preferably represents a disposable article—similar to the commercially available toilet paper rolls. With the roll according to the invention two sanitary articles needed every day hence are combined and jointly provided. The roll for example can be made of cardboard. It is also conceivable, however, that the roll is made of plastics or a biodegradable material.

In one embodiment of the roll it is provided that inside the cavity of the roll a hollow-cylindrical core element with two open sides is arranged parallel to the longitudinal axis of the roll, which core element is connected to the roll and preferably is made of the same material as the roll, wherein the wet wipes are stored in the space between the core element and the inner wall of the roll. The core element with the two open sides here assumes the position of the cardboard roll of conventional toilet paper rolls so that the roll can be hung up or plugged onto a toilet paper holder via the core element. The core element for example can be connected to the roll via a plurality of radially extending plates or struts. As the space between the core element and the inner wall of the roll is not used for hanging up on a toilet paper holder, this space can be closed off on one of the two sides so that the wet wipes can be removed only on an open side.

In another embodiment of the roll it is provided that on at least one open side the roll includes a lid to be opened and closed, which in the closed state completely covers the respective open side of the space inside the roll, in which the wet wipes are stored. Drying out of the wet wipes thereby is avoided. The lid can be made of the same material as the roll and for example of cardboard or plastics.

In another embodiment of the roll it is provided that the roll is made of a liquid-repellent material. It thereby is prevented that liquid of the wet wipes is transferred to the outer coiled cleaning cloth.

Furthermore, the present invention comprises a cleaning cloth which comprises a plurality of strip-shaped plies arranged one above the other, extending in parallel and substantially completely overlapping each other. In accordance with the invention an outer ply is configured dry, in particular as toilet paper, and the other outer ply is configured moist, in particular as wet wipe, wherein between the two outer plies a liquid-impermeable first intermediate ply is arranged.

This embodiment has the advantage that with a single tear of the cleaning cloth of the invention a dry cloth, for example a piece of generic toilet paper, as well as a wet wipe are available at the same time. Thus, a separate storage of wet wipes is not necessary. For use, either only one of the two dry or moist sides can be employed, or the sides are employed one after the other.

In one embodiment of the cleaning cloth it is provided that the first intermediate ply is made of a biodegradable material. Thereby, the quantity of non-degradable garbage can be reduced, which is produced by the additional intermediate plies.

In another embodiment of the cleaning cloth it is provided that the strip-shaped plies of the cleaning cloth in longitudinal direction are divided by perforations into portions to be torn off by hand. The perforations can be formed corresponding to the perforations on conventional toilet paper strips.

In another embodiment of the cleaning cloth it is provided that the two outer plies and preferably also the first intermediate ply of each portion are connected to each other in the edge regions oriented perpendicularly to the perforations and/or in the regions of the perforations. As a result, after tearing off you do not get a plurality of separate cloths, which under certain circumstances can be awkward to handle, but you get a single coherent piece of the cleaning cloth with a dry and a moist side.

In another embodiment of the cleaning cloth there is provided a roll on which the cleaning cloth is wound up so as to be unwound, wherein the roll in particular is configured as an open hollow cylinder and preferably is made of cardboard. The coiled cleaning cloth can thus be used like a conventional toilet paper roll with generic holders and/or dispensers.

In another embodiment of the cleaning cloth it is provided that between the individual layers of the coiled cleaning cloth a second liquid-repellent intermediate ply is arranged, which preferably is biodegradable. Each individual of the layers described here contains the different plies, namely a dry outer ply, an intermediate ply and another moist outer ply. As the different layers of the coiled cleaning cloth touch each other, the missing additional second intermediate ply would result in a contact between the moist and dry outer plies of the respective adjacent layers and thereby in an unwanted moistening of the dry plies. This is avoided by the second intermediate ply. The second intermediate ply can likewise be perforated, either at the same points as the individual layers, or at different points, in order to achieve an easier separation of the layers of the cleaning cloth and of the second intermediate ply.

At this point it should be noted that the cleaning cloths used in the various exemplary embodiments described above can also be kitchen rolls or kitchen paper or other cleaning cloths.

Further features, details and advantages of the invention can be taken from the exemplary embodiments explained with reference to the Figures, in which:

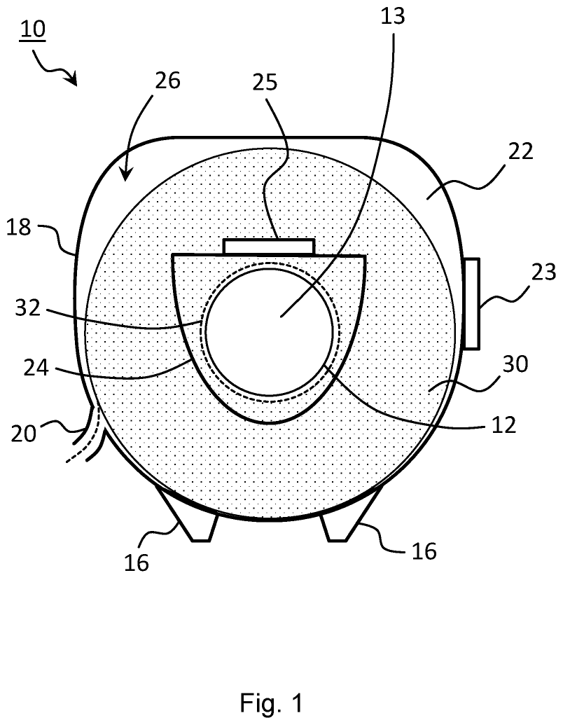

FIG. 1: shows an exemplary embodiment of the dispenser according to the invention in a front view;

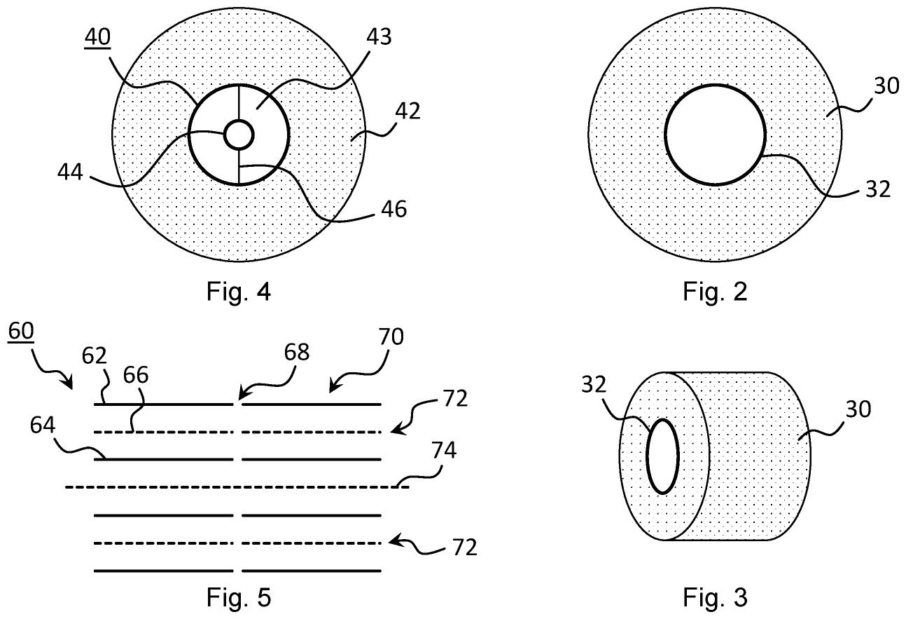

FIG. 2: shows a front view of a conventional cleaning cloth wound up on a roll for use with the dispenser according to the invention;

FIG. 3: shows the cleaning cloth of FIG. 2 in a perspective view;

FIG. 4: shows an exemplary embodiment of the roll according to the invention in a front view; and

FIG. 5: shows an exemplary embodiment of the cleaning cloth according to the invention in a schematic side view.

FIG. 1 shows an exemplary embodiment of the dispenser 10 according to the invention in a front view. In the dispenser 10 an unwindable cleaning cloth 30 wound up on a hollow-cylindrical roll 32 can be stored. In particular, this can be a commercially available dry toilet paper wound up on a cardboard roll, as it is shown in FIGS. 2 and 3.

The dispenser 10 has a housing 18, comprising a rear cover and a side facing the rear cover, which is formed by a first lid 22. FIG. 1 shows a top view of the front side of the dispenser 10 formed by the first lid 22. The first lid 22, which completely covers the interior space of the dispenser 10, is pivotally connected to the housing 18 via a hinge 23 and can be opened and closed manually. A holder 12, which is designed as a hollow cylinder, is connected to the rear cover of the dispenser 10. The outside diameter of the holder 12 is slightly smaller than the inside diameter of the roll 32 of the cleaning cloth 30. The circumferential part of the housing 18 just like the holder 12 is firmly connected to the rear cover.

The dispenser 10 furthermore includes standing feet 18 on its underside so that it can be put down on the ground. In addition, a grab handle (not shown) can be provided, which for example can be designed to fold out. Furthermore, there are provided fastening means (not shown) by means of which the dispenser 10 can be attached to a wall, for example via screws. Thus, the dispenser 10 of the invention can both be taken along and be used on the way, and can also be used stationarily as usual, for example in the sanitary field. The dispenser 10 or its housing 18, lid 22, 24 and/or holder 12 for example can be made of metal, stainless steel or plastics.

To put the cleaning cloth 30 into the dispenser 10, the hollow-cylindrical roll 32 of the cleaning cloth 30 is pushed onto the holder 12 and can be rotated thereon. The side of the cleaning cloth 30 to be torn off is guided from the interior space of the dispenser 10 through a slot-like opening 20 provided in the housing 18 to the outside. By pulling on the side of the cleaning cloth 30 guided through the opening 20, said cleaning cloth can be unwound. For tearing off, perforations oriented transversely to the rolling direction usually are provided, which divide the cleaning cloth 30 into several portions.

In the cavity 13 of the holder 12 one or more wet wipes can be stored, which can be removed or refilled on the open side facing the rear cover. To avoid having to open and close the large first lid 22 for every removal of the wet wipes, the first lid 22 has an opening which is covered by a second lid 24. The second lid 24 likewise can be opened and closed manually and is pivotally mounted on the first lid 22 via another hinge 25. With the first lid 22 closed, the opening covered by the second lid 24 completely covers the opening of the hollow-cylindrical holder 12. Thus, wet wipes can be removed from the holder 12 due to the fact that merely the smaller second lid 24 is opened or closed. The larger first lid 22 merely has to be opened for replacing the cleaning cloth 30. By covering the cavity 13 of the holder 12 by means of the second lid 24, drying out of the wet wipes is effectively avoided.

In the newly inserted state, the cleaning cloth 30 can have a diameter of 12-13 cm so that the housing 18 of the dispenser 10 can have a diameter of about 15 cm. In the exemplary embodiment shown here, the shape of the housing 18 however deviates from the cylindrical shape of the coiled cleaning cloth 30. In the upper corner regions the housing 18 is designed other than circular in shape so that two interspaces 26 are obtained. These interspaces 26 can be used as an additional stowage space for a wide variety of goods, in particular for sanitary articles such as tampons. Deviating from the shape shown here, however, any shape of the housing 18 other than the cylindrical shape can be provided in order to create an additional stowage space. What is also conceivable is the provision of additional compartments, drawers and the like on or in the dispenser 10.

In FIG. 1, the first and the second lid 22, 24 merely are shown schematically by means of their edges for better clarity so that the cleaning cloth 30 stored in the dispenser 10 can be seen along with its roll 32 rotatably mounted on the holder 12.

FIG. 4 shows a front view of an exemplary embodiment of the roll 40 according to the invention for a cleaning cloth 42 wound up on the same so as to be unwound. The cleaning cloth 42 for example can be a commercially available dry toilet paper as described above. The roller 40 can be of hollow-cylindrical shape and can be closed off on a rear side so that it has merely one open front side. Inside the cavity of the roll 40 a hollow-cylindrical core element 44 is arranged centrally in parallel to the longitudinal axis of the roll 40. The core element 44 is open on both sides. The rear opening points through the closed rear side of the roll 40 so that the space 43 between the outside of the core element 44 and the inside of the roll 40 is closed off at the rear and open at the front. In this space 43 wet wipes are stored, which can be removed through the open front side. The core element 44 is rigidly connected to the roll 40 by means of two connecting elements 46.

Due to the fact that the core element 44 is open on both sides, it assumes the position of the cardboard roll in commercially available toilet paper. Via the open core element 44, the roll 40 according to the invention is hung up or rotatably mounted on a holder or dispenser so that the cleaning cloth 42 can be unwound. To avoid drying out of the wet wipes in the interspace 43, a non-illustrated lid is provided, which closes the open front side of the space 43 and can be opened and closed manually. The lid for example can be made of plastics.

The roll 40 is made of a liquid-repellent material, for example of plastics, so that no moisture can get to the dry cleaning cloth 42. It can be made of the same material as the core element 44. It is also conceivable, however, that the roll 40 usually is made of cardboard, preferably of cardboard which on the inside is covered with a liquid-repellent layer.

Preferably, the roll 40 according to the invention is used as a disposable article. Thus, the user obtains two frequently bought or used sanitary articles in a single product.

FIG. 5 schematically shows a side view of an exemplary embodiment of the cleaning cloth 60 according to the invention. The cleaning cloth 50 is wound up on a roll (not shown) so that it can be used in the same way as commercially available toilet paper. It consists of three strip-shaped plies 62, 64, 66 arranged one above the other, extending in parallel and substantially overlapping completely. One of the outer plies 62 is configured as dry toilet paper, whereas the other outer ply 64 is configured as wet wipe. Between these two outer plies 62, 64 a liquid-repellent and biodegradable first intermediate ply 66 is arranged, which prevents that moisture from the moist outer ply 64 gets to the dry outer ply 62.

All three plies 62, 64, 66 include perforations 68 extending transversely to the longitudinal direction of the cleaning cloth 60 (which likewise defines the unwinding direction) across the entire width of the cleaning cloth 60. These perforations 68 divide the cleaning cloth 60 into a plurality of tear-off portions 70 along the longitudinal direction. Furthermore, the three plies 62, 64, 66 are connected to each other at the edge regions. After tearing off a portion 70 of the cleaning cloth 60, a coherent layer 72 with a moist and a dry side 62, 64 thereby is available.

To avoid that in the case of the cleaning cloth 60 wound up on a roll the moist outer play 64 of a layer moistens the dry outer ply 62 of the adjacent layer 72, a second liquid-repellent and biodegradable intermediate ply 74 is provided, which is arranged between the individual layers 72 of the cleaning cloth 60. The second intermediate ply 74 likewise includes perforations (not shown) which can be identical or can be arranged offset from the perforations of the individual layers 72. The first and second intermediate plies 66, 72 for example can be made of baking paper.

### REFERENCE NUMERALS

10 dispenser
12 holder
13 cavity
16 standing foot
18 housing
20 opening
22 first lid
23 hinge
24 second lid
25 hinge
26 interspace
30 cleaning cloth
32 roll
40 roll
42 cleaning cloth
43 cavity/interspace
44 core element
46 connecting element
60 cleaning cloth
62 dry outer ply
64 moist outer ply
66 first intermediate ply
68 perforation
70 portion
72 layer
74 second intermediate ply

1. A dispenser for an unwindable cleaning cloth wound on a hollow-cylindrical roll, the dispenser comprising a holder attached to a rear cover, whose outside diameter is smaller than an inside diameter of the roll, for accommodating the roll of the coiled cleaning cloth,
wherein the holder is of hollow-cylindrical shape and configured with an open end facing the rear cover, wherein inside a cavity of the holder one or more wet wipes can be stored, which can be removed and refilled through the open end.

2. The dispenser according to claim 1, further comprising a grab handle.

3. The dispenser according to claim 1, further comprising at least two standing feet.

4. The dispenser according to claim 1, further comprising at least one fastening means is provided for attaching the dispenser to a wall.

5. The dispenser according to claim 1, wherein the dispenser includes a housing which completely or almost completely encloses a coiled cleaning cloth stored therein, wherein the rear cover is part of the housing, wherein the housing includes an opening for unrolling and removing the cleaning cloth and wherein a side of the housing facing the rear cover is formed by a first lid to be opened and closed.

6. The dispenser according to claim 5, wherein the first lid has an opening which covers an open side of the holder when the first lid is closed, wherein on the first lid a second lid is mounted, which can be opened and closed and which in a closed state covers the opening of the first lid.

7. The dispenser according to claim 5, wherein the housing deviates from a substantially cylindrical shape of the coiled cleaning cloth, wherein interspaces resulting from the deviation are configured as additional storage compartments.

8. A roll on which a dry cleaning cloth is wound so as to be unwound, and which is configured as a hollow cylinder with at least one open side,
wherein a cavity of the roll contains one or more wet wipes which can be removed and/or refilled through the at least one open side of the roll.

9. The roll according to claim 8, wherein inside the cavity of the roll parallel to its longitudinal axis a hollow-cylindrical core element with two open sides is arranged, which is connected to the roll and wherein the wet wipes are stored in a space between the core element and an inner wall of the roll.

10. The roll according to claim 8, wherein on at least one open side the roll includes a lid to be opened and closed, which in a closed state completely covers a respective open side of the space inside the roll, in which the wet wipes are stored.

11. The roll according to claim 8, wherein the roll is made of a liquid-repellent material.

12. A cleaning cloth comprising a plurality of strip-shaped plies arranged one above the other, extending in parallel and substantially completely overlapping each other,
wherein a first outer ply is configured dry, in particular as toilet paper, and a second outer ply is configured moist as wet wipe, wherein between the first and second outer plies a liquid-impermeable first intermediate ply is arranged.

13. The cleaning cloth according to claim 12, wherein the first intermediate ply is made of a biodegradable material.

14. The cleaning cloth according to claim 12, wherein in a longitudinal direction the strip-shaped plies of the cleaning cloth are divided by perforations into portions to be torn off by hand.

15. The cleaning cloth according to claim 14, wherein the first and second outer plies of each portion are connected to each other in edge regions oriented perpendicularly to the perforations and/or in the regions of the perforations.

16. The cleaning cloth according to any of claim 12, wherein there is provided a roll on which the cleaning cloth is wound so as to be unwound, wherein the roll is configured as an open hollow cylinder and is made of cardboard.

17. The cleaning cloth according to claim 16, wherein between individual layers of the coiled cleaning cloth a second liquid-repellent intermediate ply is arranged.

18. The dispenser according to claim 3, wherein the at least two provided standing feet are arranged on an underside of the dispenser.

19. The dispenser according to claim 5, wherein the first lid is pivotally mounted on the housing.

20. The cleaning cloth according to claim 17, wherein the second liquid-repellent intermediate ply is biodegradable.
